(19) United States
(12) Patent Application Publication
(10) Pub. No.: US 2017/0137557 A1
(43) Pub. Date: May 18, 2017

(54) PROCESS FOR PRODUCING ISOCYANATE-BASED FOAM CONSTRUCTION BOARDS

(71) Applicant: FIRESTONE BUILDING PRODUCTS CO., LLC, Indianapolis, IN (US)

(72) Inventors: Chunhua YAO, Carmel, IN (US); John LETTS, Carmel, IN (US)

(73) Assignee: FIRESTONE BUILDING PRODUCTS CO., LLC, Indianapolis, IN (US)

(21) Appl. No.: 15/350,634

(22) Filed: Nov. 14, 2016

Related U.S. Application Data
(60) Provisional application No. 62/255,033, filed on Nov. 13, 2015.

(51) Int. Cl. C08G 18/08; C08G 18/42; C08J 9/14; C08G 18/72

(52) U.S. Cl. CPC C08G 18/14; C08G 18/72; C08G 18/42; C08J 9/141; C08J 2375/06; C08J 2203/14; C08J 2205/052

(57) ABSTRACT

A process for producing a polyurethane or polyisocyanurate construction board, the process comprising of providing an A-side reactant stream that includes an isocyanate-containing compound; providing a B-side reactant stream that includes a polyol, where the B-side reactant steam includes at least 0.5 parts by weight water per 100 parts by weight polyol within the B-side stream; and mixing the A-side reactant stream with the B-side reactant stream to produce a reaction mixture.

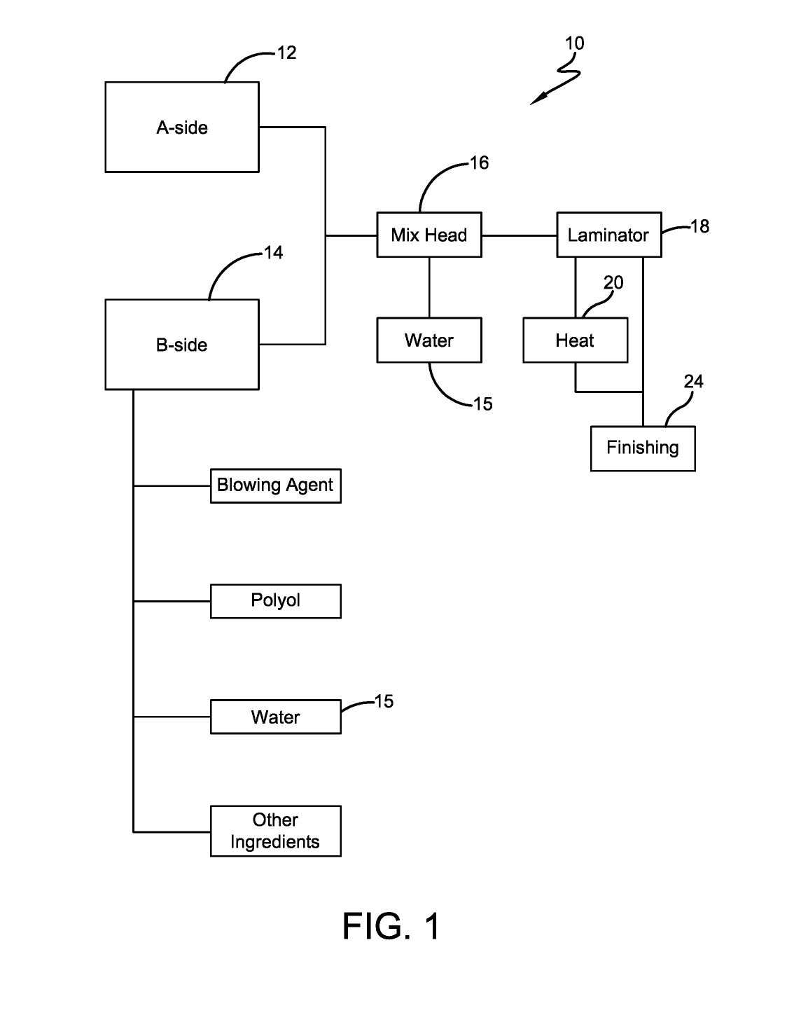

This application claims the benefit of U.S. Provisional Application Ser. No. 62/255,033, filed on Nov. 13, 2015, which is incorporated herein by reference.

### FIELD OF THE INVENTION

Embodiments of the present invention are directed toward a process for producing isocyanate-based foam construction boards (e.g. polyurethane and polyisocyanurate boards) having improved insulating properties. In one or more embodiments, the construction boards are prepared by including threshold amounts of water within the foam-forming ingredients.

### BACKGROUND OF THE INVENTION

Polyurethane and polyisocyanurate foam construction boards are commonly employed in the construction industry. For example, foam insulation boards are commonly employed as insulation within flat or low-sloped roofs. Isocyanate-based cover boards, which are high density boards, are also employed in many roof systems as a protective layer.

Isocyanate-based construction boards are cellular in nature and typically include an insulating compound trapped within the closed cells of the foam. Many insulating compounds have been used over the years. For example, halogenated hydrocarbons, such as trichlorofluoromethane (CFC-11), were employed. These materials were phased out in favor of hydrochlorofluorocarbons, such as 1,1-dichloro-1-fluoroethane (HCFC-141b). The hydrochlorofluorocarbons were then replaced with hydrocarbons such as various pentane isomers. For example, it is common to produce construction boards by employing n-pentane, isopentane, and/or cyclopentane as blowing agents.

Construction boards are often characterized by one or more technologically important characteristics. For example, the isocyanate-based construction boards may be characterized by an ISO index, which generally refers to the molar ratio of polyisocyanurate (PIR) to polyurethane (PUR) linkages within a given foam system. Typically, the ISO index is determined by IR spectroscopy using standard foams of known index. Where, for example, the PIR/PUR ratio is 2, the foam is designated with an index of 200. Insulation and cover boards having an index of greater than about 200 are desirable because these foam construction boards demonstrate improved dimensional stability and better flame resistance than lower index foams.

Another technologically important characteristic is the insulating property of the foam construction board. This characteristic is typically quantified based upon “R-Value.” As a skilled person will appreciate, R-Value represents the ability of a given material to resist heat transfer. This resistance can change with the temperature differential being observed, as well as the median temperature. For example, consumer products are often designated with an R-Value measured at a 40° F. differential and a median temperature of 75° F.; in other words, the insulating value is determined between environments set at 55° F. and 95° F. It is often important to measure R-Value by employing a 40° F. differential at a 40° F. median temperature (i.e. between environments set at 20° F. and 60° F.). Generally speaking, due to thermodynamic phenomena, R-Value is typically higher at lower median temperatures.

It is obviously desirable to increase the insulating ability of the foam construction boards without drastically altering other characteristics of the board such as the thickness. In particular, there is a desire to maintain the insulating properties of construction boards over longer periods of time.

### SUMMARY OF THE INVENTION

Embodiments of the invention provide a process for producing a polyurethane or polyisocyanurate construction board, the process comprising of providing an A-side reactant stream that includes an isocyanate-containing compound; providing a B-side reactant stream that includes a polyol, where the B-side reactant steam includes at least 0.5 parts by weight water per 100 parts by weight polyol within the B-side stream; and mixing the A-side reactant stream with the B-side reactant stream to produce a reaction mixture.

Other embodiments of the invention provide a process for producing a polyurethane or polyisocyanurate construction board, the process comprising of combining polyol, isocyanate, and water to form a foam-forming mixture, where at least 0.5 parts by weight water per 100 parts polyol is combined; depositing the foam-forming mixture on a facer; and heating the foam-forming mixture to form a closed-cell foam.

### BRIEF DESCRIPTION OF THE DRAWINGS

The FIGURE is a flow chart showing a process of one or more embodiments of the invention.

### DETAILED DESCRIPTION OF ILLUSTRATIVE EMBODIMENTS

Embodiments of the present invention are based, at least in part, on the discovery of a process for producing isocyanate-based construction boards that includes maintaining threshold amounts of water within the foam-forming ingredients. In particular embodiments, these threshold amounts of water are included in the isocyanate-reactive stream of reactants (which is often referred to as the B-side stream) that are combined with the isocyanate compounds during formation of the foam. Despite what may have been predicted thermodynamically, it has been observed that relatively high index foam construction boards that are prepared by employing aromatic polyester polyols and hydrocarbon blowing agents have an R-Value at a 40° F. median temperature that is lower than the R-Value at a 75° F. median temperature. In the face of this, it has unexpectedly been found that by maintaining threshold amounts of water within the foam-forming ingredients, the insulating properties of these resultant construction boards can be increased at lower median temperatures (e.g. 40° F.).

### Process Overview

As suggested above, practice of the present invention includes preparing an isocyanate-based foam by employing reactants that include a threshold amount of water. As used herein, the term isocyanate-based foam may include polyurethane and polyisocyanurate foams, and terms foam, polyurethane and polyisocyanate may be generally used interchangeably unless specifically indicated. For example, where a technical distinction must be made between polyurethane and polyisocyanurate foam, the ISO index will be used to make any required technical distinctions.

In one or more embodiments, the foam is prepared by mixing a first stream that includes an isocyanate-containing compound with a second stream that includes an isocyanate-reactive compound. Using conventional terminology, the first stream (i.e., the stream including an isocyanate-containing compound) may be referred to as an A-side stream, an A-side reactant stream, or simply an A stream. Likewise, the second stream (i.e., the stream including an isocyanate-reactive compound) may be referred to as a B-side stream, B-side reactant stream, or simply B stream. In one or more embodiments, either stream may carry additional ingredients including, but not limited to, flame-retardants, surfactants, blowing agents, catalysts, emulsifiers/solubilizers, fillers, fungicides, anti-static substances, and mixtures of two or more thereof.

In one or more embodiments, the threshold amount of water in accordance with practice of this invention is included within the B-side stream of reactants.

In one or more embodiments, the threshold amount of water includes at least 0.5, in other embodiments at least 0.75, and in other embodiments at least 1.0 parts by weight water per 100 parts by weight polyol. In these or other embodiments, the threshold amount of water includes at most 3.0, in other embodiments at most 2.5, and in other embodiments at most 2.0 parts by weight water per 100 parts by weight polyol. In one or more embodiments, the amount of water included within the included within the B-side stream of reactants is from about 0.5 to about 3.0, in other embodiments from about 0.75 to about 2.5, and in other embodiments from about 1.0 to about 2.0 parts by weight water per 100 parts by weight polyol. It should be understood that these amounts can likewise be employed even where the water is introduced directly to the mixhead, as will be explained in greater detail below.

### A-Side Stream

In one or more embodiments, the A-side stream may only contain the isocyanate-containing compound. In one or more embodiments, multiple isocyanate-containing compounds may be included in the A-side. In other embodiments, the A-side stream may also contain other constituents such as, but not limited to, flame-retardants, surfactants, blowing agents and other non-isocyanate-reactive components. In one or more embodiments, the complementary constituents added to the A-side are non-isocyanate reactive.

Suitable isocyanate-containing compounds useful for the manufacture of polyisocyanurate construction board are generally known in the art and embodiments of this invention are not limited by the selection of any particular isocyanate-containing compound. Useful isocyanate-containing compounds include polyisocyanates. Useful polyisocyanates include aromatic polyisocyanates such as diphenyl methane diisocyanate in the form of its 2,4′-, 2,2′-, and 4,4′-isomers and mixtures thereof. The mixtures of diphenyl methane diisocyanates (MDI) and oligomers thereof may be referred to as “crude” or polymeric MDI, and these polyisocyanates may have an isocyanate functionality of greater than 2. Other examples include toluene diisocyanate in the form of its 2,4′ and 2,6′-isomers and mixtures thereof, 1,5-naphthalene diisocyanate, and 1,4′ diisocyanatobenzene. Exemplary polyisocyanate compounds include polymeric Rubinate 1850 (Huntsmen Polyurethanes), polymeric Lupranate M70R (BASF), and polymeric Mondur 489N (Bayer).

### B-Side Stream

In one or more embodiments, the B-side stream may only include the isocyanate-reactive compound and the water. In one or more embodiments, multiple isocyanate-reactive compounds may be included in the B-side. In other embodiments, the B-side stream may also contain other constituents such as, but not limited to, flame-retardants, surfactants, blowing agents and other non-isocyanate-containing components. In particular embodiments, the B-side includes an isocyanate reactive compound and a blowing agent. In these or other embodiments, the B-side may also include flame retardants, catalysts, emulsifiers/solubilizers, surfactants, fillers, fungicides, anti-static substances, and other ingredients that are conventional in the art.

An exemplary isocyanate-reactive compound is a polyol. The term polyol, or polyol compound, includes diols, polyols, and glycols, which may contain water as generally known in the art. Primary and secondary amines are suitable, as are polyether polyols and polyester polyols. In particular embodiments, aromatic polyester polyols are employed. Exemplary polyester polyols include phthalic anhydride based PS-2352 (Stepen), phthalic anhydride based polyol PS-2412 (Stepen), teraphthalic based polyol 3522 (Kosa), and a blended polyol TR 564 (Oxid). Useful polyether polyols include those based on sucrose, glycerin, and toluene diamine. Examples of glycols include diethylene glycol, dipropylene glycol, and ethylene glycol. Suitable primary and secondary amines include, without limitation, ethylene diamine, and diethanolamine. In one or more embodiments, a polyester polyol is employed. In one or more embodiments, the present invention may be practiced in the appreciable absence of any polyether polyol. In certain embodiments, the ingredients are devoid of polyether polyols.

### Catalysts

Catalysts, which are believed to initiate the polymerization reaction between the isocyanate and the polyol, as well as a trimerization reaction between free isocyanate groups when polyisocyanurate foam is desired, may be employed. While some catalysts expedite both reactions, two or more catalysts may be employed to achieve both reactions. Useful catalysts include salts of alkali metals and carboxylic acids or phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyldiethylene triamine (PMDETA), 2,4,6-tris [(dimethylamino)methyl]phenol, triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

### Surfactants, Emulsifiers and Solubilizers

Surfactants, emulsifiers, and/or solubilizers may also be employed in the production of polyurethane and polyisocyanurate foams in order to increase the compatibility of the blowing agents with the isocyanate and polyol components. Surfactants may serve two purposes. First, they may help to emulsify/solubilize all the components so that they react completely. Second, they may promote cell nucleation and cell stabilization.

Exemplary surfactants include silicone co-polymers or organic polymers bonded to a silicone polymer. Although surfactants can serve both functions, it may also be useful to ensure emulsification/solubilization by using enough emulsifiers/solubilizers to maintain emulsification/solubilization and a minimal amount of the surfactant to obtain good cell nucleation and cell stabilization. Examples of surfactants include Pelron surfactant 9920, Evonik 58489, and GE 6912. U.S. Pat. Nos. 5,686,499 and 5,837,742 are incorporated herein by reference to show various useful surfactants.

Suitable emulsifiers/solubilizers include DABCO Ketene 20AS (Air Products), and Tergitol NP-9 (nonylphenol+9 moles ethylene oxide).

### Flame Retardants

Flame Retardants may be used in the production of polyurethane and polyisocyanurate foams, especially when the foams contain flammable blowing agents such as pentane isomers. Useful flame retardants include tri(monochloropropyl) phosphate (a.k.a. tris(cloro-propyl) phosphate), tri-2-chloroethyl phosphate (a.k.a tris(chloro-ethyl) phosphate), phosphonic acid, methyl ester, dimethyl ester, and diethyl ester. U.S. Pat. No. 5,182,309 is incorporated herein by reference to show useful blowing agents.

### Blowing Agents

Useful blowing agents include isopentane, n-pentane, cyclopentane, alkanes, (cyclo)alkanes, hydrofluorocarbons, hydrochlorofluorocarbons, fluorocarbons, fluorinated ethers, alkenes, alkynes, carbon dioxide, hydrofluoroolefins (HFOs) and noble gases.

### Amount of Reactants

An isocyanurate is a trimeric reaction product of three isocyanates forming a six-membered ring. The ratio of the equivalence of NCO groups (provided by the isocyanate-containing compound or A-side) to isocyanate-reactive groups (provided by the isocyanate-containing compound or B side) may be referred to as the index or ISO index. When the NCO equivalence to the isocyanate-reactive group equivalence is equal, then the index is 1.00, which is referred to as an index of 100, and the mixture is said to be stoiciometrically equal. As the ratio of NCO equivalence to isocyanate-reactive groups equivalence increases, the index increases. Above an index of about 150, the material is generally known as a polyisocyanurate foam, even though there are still many polyurethane linkages that may not be trimerized. When the index is below about 150, the foam is generally known as a polyurethane foam even though there may be some isocyanurate linkages. For purposes of this specification, reference to polyisocyanurate and polyurethane will be used interchangeably unless a specific ISO index is referenced.

In one or more embodiments, the concentration of the isocyanate-containing compound to the isocyanate-reactive compounds within the respective A-side and B-side streams is adjusted to provide the foam product with an ISO index of at least 150, in other embodiments at least 170, in other embodiments at least 190, in other embodiments at least 210, in other embodiments at least 220, in other embodiments at least 225, in other embodiments at least 230, in other embodiments at least 235, in other embodiments at least 240, in other embodiments at least 245, and in other embodiments at least 250. In these or other embodiments, the concentration of the isocyanate-containing compound to the isocyanate-reactive compounds within the respective A-side and B-side streams is adjusted to provide the foam product with an ISO index of at most 400, in other embodiments at most 350, and in other embodiments at most 300. In one or more embodiments, the concentration of the isocyanate-containing compound to the isocyanate-reactive compounds within the respective A-side and B-side streams is adjusted to provide the foam product with an ISO index of from about 150 to about 400, in other embodiments from about 170 to about 350, and in other embodiments from about 190 to about 330, and in other embodiments from about 220 to about 280.

In one or more embodiments, the amount of alkane blowing agent (e.g., pentanes) used in the manufacture of polyisocyanurate foam construction board according to the present invention may be described with reference to the amount of isocyanate-reactive compound employed (e.g. polyol). For example, in one or more embodiments, at least 12, in other embodiments at least 14, and in other embodiments at least 18 parts by weight alkane blowing agent per 100 parts by weight of polyol may be used. In these or other embodiments, at most 40, in other embodiments at most 36, and in other embodiments at most 33 parts by weight alkane blowing agent per 100 parts by weight of polyol may be used. In one or more embodiments, from about 12 to about 40, in other embodiments from about 14 to about 36, and in other embodiments from about 18 to about 33 of alkane blowing agent per 100 parts by weight of polyol may be used.

In one or more embodiments, the amount of hydrofluoroolefin blowing agent used in the manufacture of polyisocyanurate foam construction board according to the present invention may be described with reference to the amount of isocyanate-reactive compound employed (e.g. polyol). For example, in one or more embodiments, at least 15, in other embodiments at least 18, and in other embodiments at least 20 parts by weight hydrofluoroolefin blowing agent per 100 parts by weight of polyol may be used. In these or other embodiments, at most 50, in other embodiments at most 45, and in other embodiments at most 40 parts by weight hydrofluoroolefin blowing agent per 100 parts by weight of polyol may be used. In one or more embodiments, from about 15 to about 50, in other embodiments from about 18 to about 45, and in other embodiments from about 20 to about 40 of hydrofluoroolefin blowing agent per 100 parts by weight of polyol may be used.

In one or more embodiments, the amount of surfactant (e.g., silicone copolymer) used in the manufacture of polyisocyanurate foam construction board according to the present invention may be described with reference to the amount of isocyanate-reactive compound employed (e.g., polyol). For example, in one or more embodiments, at least 1.0, in other embodiments at least 1.5, and in other embodiments at least 2.0 parts by weight surfactant per 100 parts by weight of polyol may be used. In these or other embodiments, at most 5.0, in other embodiments at most 4.0, and in other embodiments at most 3.0 parts by weight surfactant per 100 parts by weight of polyol may be used. In one or more embodiments, from about 1.0 to about 5.0, in other embodiments from about 1.5 to about 4.0, and in other embodiments from about 2.0 to about 3.0 of surfactant per 100 parts by weight of polyol may be used.

In one or more embodiments, the amount of flame retardant (e.g., liquid phosphates) used in the manufacture of polyisocyanurate foam construction board according to the present invention may be described with reference to the amount of isocyanate-reactive compound employed (e.g., polyol). For example, in one or more embodiments, at least 5, in other embodiments at least 10, and in other embodiments at least 12 parts by weight flame retardant per 100 parts by weight of polyol may be used. In these or other embodiments, at most 30, in other embodiments at most 25, and in other embodiments at most 20 parts by weight flame retardant per 100 parts by weight of polyol may be used. In one or more embodiments, from about 5 to about 30, in other embodiments from about 10 to about 25, and in other embodiments from about 12 to about 20 of flame retardant per 100 parts by weight of polyol may be used.

In one or more embodiments, the amount of catalyst(s) employed in practice of the present invention can be readily determined by the skilled person without undue experimentation or calculation. Indeed, the skilled person is aware of the various process parameters that will impact the amount of desired catalyst.

In one or more embodiments, the amount of blowing agent (together with the amount of water) that is employed is sufficient to provide a foam having a foam density (ASTM C303) that is less than 2.5 pounds per cubic foot (12 kg/m2), in other embodiments less than 2.0 pounds per cubic foot (9.8 kg/m2), in other embodiments less than 1.9 pounds per cubic foot (9.3 kg/m2), and still in other embodiments less than 1.8 pounds per cubic foot (8.8 kg/m2). In one or more embodiments, the amount of blowing agent (together with the amount of water) that is employed is sufficient to provide a density that is greater than 1.50 pounds per cubic foot (7.32 kg/m2), or in other embodiments, greater than 1.55 pounds per cubic foot (7.57 kg/m2).

### Method of Making

An overview of a process according to embodiments of the present invention can be described with reference to the FIGURE. The process 10 includes providing an A-side stream of reactants 12 and a B-side stream of reactants 14. As described above, the A-side stream of reactants includes an isocyanate-containing compounds and the B-side stream of reactants includes an isocyanate-reactive compound. In accordance with the present invention, a threshold amount of water 15 is included within the B-side stream to ensure that the specified threshold amounts are present it the B-side. The order in which the ingredients are added in forming the B-side stream can be varied. And, the timing of the addition of the water can be varied. For example, in one or more embodiments, water is combined with the polyol within a batch mixer together with one or more of the other ingredients except for the blowing agent. Once this initial mixture is prepared, the blowing agent can be added to the mixture to form the B-side stream. The skilled person will readily appreciate other orders of addition that can be employed.

In one or more embodiments, the step of introducing water to the B-side stream includes analyzing the B-side stream to determine the amount of water present in the raw materials within the B-side, and then subsequently adding water to the B-side to bring the level of water within the prescribed threshold amounts. In other embodiments, as also shown in the FIGURE, water 15 can be introduced directly to mixhead 16, where it is simultaneously introduced to the A-side and B-side stream of reactants.

In one or more embodiments, water is introduced to the B-side stream of reactants by using an in-line continuous mixer at a pressure of less than 3,400 kPa, wherein the water and the polyol component are continuously charged in separate streams advanced at predetermined flow rates chosen to bring about a desired ratio of water to polyol component within the in-line mixer. In one or more embodiments, the water and the polyol are mixed at pressure of a less than 3,400 kPa to dissolve or emulsify the polyol and water within the B-side stream. Methods by which the water may be introduced to the B-side stream include those methods for introducing other constituents to the B-side stream, and in this regard, U.S. Publ. No. 2004/0082676 is incorporated herein by reference.

In one or more embodiments, the water is introduced to the B-side stream (i.e., combined with the polyol) prior to introducing the blowing agent to the B-side stream. In these or other embodiments, the water is introduced to the B-side stream (i.e., combined with the polyol) after introducing the blowing agent to the B-side stream. In these or embodiments, the water is introduced to the B-side stream (i.e. combined with the polyol) simultaneously with the blowing agent.

The respective streams (12, 14) are mixed within, for example, a mixhead 16 to produce a reaction mixture. Embodiments of the present invention are not limited by the type of mixing or device employed to mix the A-side stream and the B-side stream. In one or more embodiments, the A-side stream of reactants and the B-side stream of reactants may be mixed within an impingement mixhead. In particular embodiments, mixing takes place at a temperature of from about 5 to about 45° C. In these or other embodiments, mixing takes place at a pressure in excess of 2,000 psi.

The mixture can then be deposited onto a facer that is positioned within and carried by a laminator 18. While in laminator 18, the reaction mixture rises and can be married to a second facer to form a composite, which may also be referred to as a laminate, wherein the foam is sandwiched between upper and lower facers. The composite, while in laminator 18, or after removal from laminator 18, is exposed to heat that may be supplied by, for example, oven 20. For example, laminator 18 may include an oven or hot air source that heats the slats and side plates of the laminator and there through transfers heat to the laminate (i.e., to the reaction mixture).

Once subjected to this heat, the composite (i.e., the reaction mixture), or a portion of the composite (i.e., reaction mixture) can undergo conventional finishing within a finishing station 24, which may include, but is not limited to, trimming and cutting.

Various modifications and alterations that do not depart from the scope and spirit of this invention will become apparent to those skilled in the art. This invention is not to be duly limited to the illustrative embodiments set forth herein.

What is claimed is:

1. A process for producing a polyurethane or polyisocyanurate construction board, the process comprising:
(i) providing an A-side reactant stream that includes an isocyanate-containing compound;
(ii) providing a B-side reactant stream that includes a polyol, where the B-side reactant steam includes at least 0.5 parts by weight water per 100 parts by weight polyol within the B-side stream;
(iii) mixing the A-side reactant stream with the B-side reactant stream to produce a reaction mixture.

2. The process of claim 1, further comprising the step of exposing the reaction mixture to heat.

3. The process of claim 1, where the reaction mixture is deposited onto a facer.

4. The process of claim 1, where the reaction is formed into a foam construction board within a laminator.

5. The process of claim 1, where the B-side reactant stream includes at least 0.75 parts by weight water per 100 parts by weight polyol.

6. The process of claim 1, where the B-side reactant stream includes at least 1.0 parts by weight water per 100 parts by weight polyol.

7. The process of claim 1, where the process produces a construction board having an index of at least 220.

8. The process of claim 1, where the process produces a construction board having an index of at least 225.

9. The process of claim 1, where the polyol is an aromatic polyester polyol.

10. The process of claim 1, where the B-side stream includes a hydrocarbon blowing agent.

11. The process of claim 1, where the blowing agent includes a pentane.

12. The process of claim 1, where the blowing agent includes n-pentane, isopentane, cyclopentane, or a mixture of two or more thereof.

13. A process for producing a polyurethane or polyisocyanurate construction board, the process comprising:
(i) combining polyol, isocyanate, and water to form a foam-forming mixture, where at least 0.5 parts by weight water per 100 parts polyol is combined;
(ii) depositing the foam-forming mixture on a facer;
(iii) heating the foam-forming mixture to form a closed-cell foam.
